(19) United States
(12) Patent Application Publication
(10) Pub. No.: US 2019/0195726 A1
(43) Pub. Date: Jun. 27, 2019

(54) SYSTEM AND METHOD FOR INSPECTION OF ROTATING OR BURIED ELEMENTS

(71) Applicant: TECHNISCHE UNIVERSITAT HAMBURG, Hamburg (DE)

(72) Inventors: Bodo FIEDLER, Hamburg (DE); Daniel VON BERNSTORFF, Hamburg (DE)

(21) Appl. No.: 16/301,109

(22) PCT Filed: May 12, 2017
(86) PCT No.: PCT/EP2017/061434

§ 371 Date: Nov. 13, 2018

(30) Foreign Application Priority Data
May 12, 2016 (LU) 93071

(51) Int. Cl. G01M 5/00; G01L 1/18

(52) U.S. Cl. CPC G01M 5/0041; G01L 1/18

(57) ABSTRACT

The invention relates to a System (1) for inspection of rotating or buried elements (E), comprising: ⋅a flexible sensor band (B), ⋅whereby the flexible sensor band (B) comprises a first sensor arrangement (S) for detecting mechanical stress at the rotating or buried element (E), ⋅whereby the flexible sensor band (B) comprises a second sensor arrangement (S₂) for detecting humidity at the rotating or buried element, ⋅whereby the flexible sensor band (B) further comprises an energy harvesting section (BAT), ⋅whereby the flexible sensor band (B) further comprises a wireless communication section (TX), the wireless communication section (TX) being adapted to transmit data relating to the detected mechanical of the first sensor arrangement (S) and a unique ID (ID) relating to the first sensor arrangement (S) towards a receiving section (RX), whereby the wireless communication section (TX) is further adapted to transmit data relating to the detected humidity towards said receiving section (RX), ⋅the receiving section (RX) being arrangeable at a position such that the flexible sensor hand (B) when the rotating or buried element (E) is passing the receiving section (RX) may transmit the data towards the receiving section (RX). The invention also pertains to a method associated to the system.

### BACKGROUND

It is known in many fields in the art that material tends to degrade. Degradation may be endued chemically and/or physically. E.g. corrosion is a form a chemical degradation which might impair stability of a material. Mechanical stress may lead to abrasion as well as to cracks in the internal structure of elements which might as well impair stability of material.

To detect these problems it is necessary either to replace the respective material after a certain time or to check these materials for any structural impairment which might be dangerous.

Systems allowing for determination of stress are known in the art. For example measurement based on fiber optic employing Bragg-gratings or strain gauges or acoustic emissions are known.

Strain gauges, for example, are based on metallic strips affording bulky evaluation circuits and necessitating rather high energy amounts. These strain gauges need calibration which is time consuming and expensive. Also the attachment is quite delicate and typically affords soldering. Due to their metallic contents these systems may not be employed within wind power plants as they tend to attract lightning.

Fiber Bragg gratings are sometimes used for monitoring large areas. There, optical fibers are embedded into the structures to be monitored. The fibers are changing their reflectivity/scattering due to mechanical stress. While these approaches allows for monitoring large areas, it is problem that the fibers employed are relatively bulky. In order to allow for measurements the fiber must be embedded which then most often interferes with the production process. Furthermore these fibers are temperature sensitive such that the operation range is rather limited.

Acoustic emissions are produced when matrix or fibres of a composite material degrade. While the system allows for a determination of a failure it is not able to provide an indication of the location thereof in case of single AE-detector. In particular when the elements to be monitored are complex and/or rigid these systems tend to provide no reliable results.

However, these approaches may allow measurements at high costs or the measurements systems itself is error prone due to degradation or the measurements systems do not fit to the structural dimensions to be measured or provide only a limited resolution.

I.e., while these approaches might work in some areas there exist applications where such undertaking is either to costly or not feasible at all.

Suppose machinery such as an offshore windturbine. There it is quite often not possible to check material thereof—such as blades of the windturbine—at a certain time. Blades are known to be expensive in terms of production as well as in terms of assembly. Hence, it is not effective to replace them while they still could be employed. On the other hand checking of a rotating blade is not yet possible. Time to check such a blade is limited, i.e. the weather conditions most often do not allow for extended measurements.

A like problem arises when checking stability of certain buildings such as bridges or other machinery. There most often the error prone materials are located at places where a check may not be performed without major deconstruction or they might not even be accessible at all.

It therefore exist a need for improved systems and methods allowing for inspection of such materials.

To overcome one or more problems in the art, the invention proposes a System and method for inspection of rotating or buried elements.

The System for inspection of rotating or buried elements according to the invention comprises a flexible sensor band, the flexible sensor band may having at least one adhesive surface for attaching on a rotating or buried element, whereby the flexible sensor band comprises a first sensor arrangement for detecting mechanical stress at the rotating or buried element, whereby the flexible sensor band comprises a second sensor arrangement for detecting humidity at the rotating or buried element, whereby the flexible sensor band further comprises an energy harvesting section, whereby the flexible sensor band further comprises a wireless communication section, the wireless communication section being adapted to transmit data relating to the detected mechanical of the first sensor arrangement and a unique ID relating to the first sensor arrangement towards a receiving section, whereby the wireless communication section is further adapted to transmit data relating to the detected humidity towards said receiving section. The system also comprises a receiving section which is arrangeable at a position such that the flexible sensor band when the rotating or buried element is passing the receiving section may transmit the data towards the receiving section.

The invention also offers a method for inspection of rotating or buried elements by a system comprising the steps of applying the flexible sensor band having at least one adhesive surface on a rotating or buried element, the step of energy harvesting for providing energy towards the sensor arrangement and the wireless communication section, the step of detecting mechanical stress at the rotating or buried element by sensor arrangement, and the step of transmitting data relating to the detected mechanical stress of the sensor arrangement and a unique ID relating to the sensor arrangement towards a receiving section.

Further details are subject to the dependent claims and the description.

### SHORT SUMMARY OF THE FIGURES

In the following detailed description reference will be made towards the figures, in which

FIG. 1 shows a schematic overview of flexible sensor band according to the invention,

FIG. 2 shows a schematic overview of logical elements of a system according to the invention, and

FIG. 3 shows another aspect of the invention,

### DETAILED DESCRIPTION

The present disclosure describes preferred embodiments with reference to the Figures, in which like reference signs represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, method steps or characteristics of the invention may be combined in any suitable manner in one or more embodiments. In the description, numerous specific details are recited to provide a thorough understanding of embodiments of the invention.

I.e., unless indicated as alternative only any feature of an embodiment may also be utilized in another embodiment.

In addition, even though at some occurrences certain features will be described with reference to a single entity, such a description is for illustrative purpose only and actual implantations of the invention may also comprise one or more of these entities. I.e. usage of singular also encompasses plural entities unless indicated.

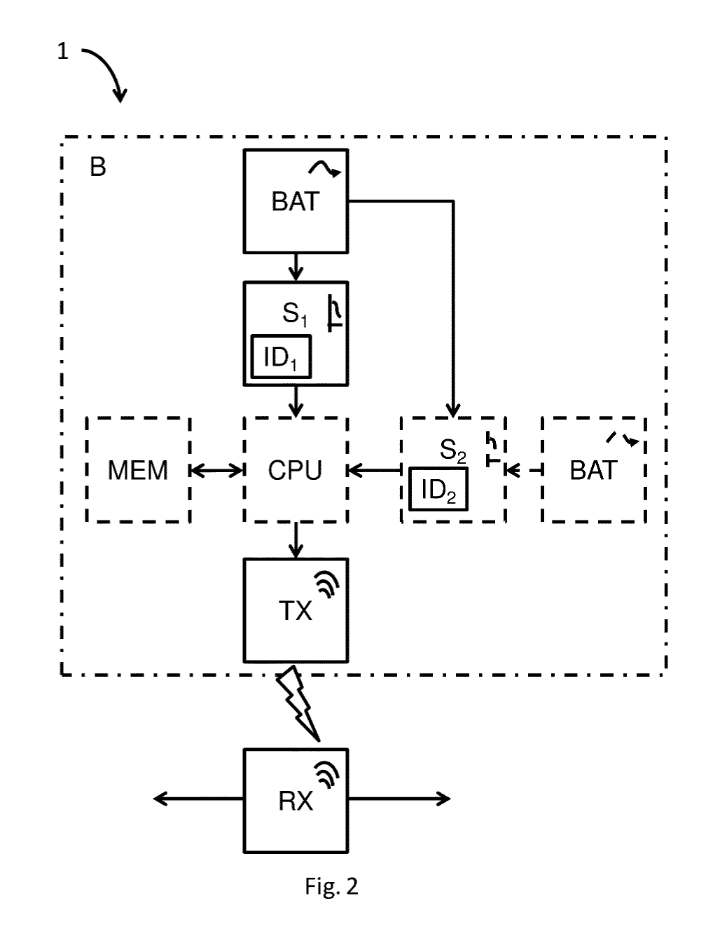

A system 1 according to the invention is shown schematically in FIG. 2. The System 1 for inspection of rotating or buried elements E comprises a flexible sensor band B. The term rotating or buried element should not be construed in a limiting manner but is to be understood as an element which is difficult to access. E.g. within the car body it is quite difficult to measure mechanical stress.

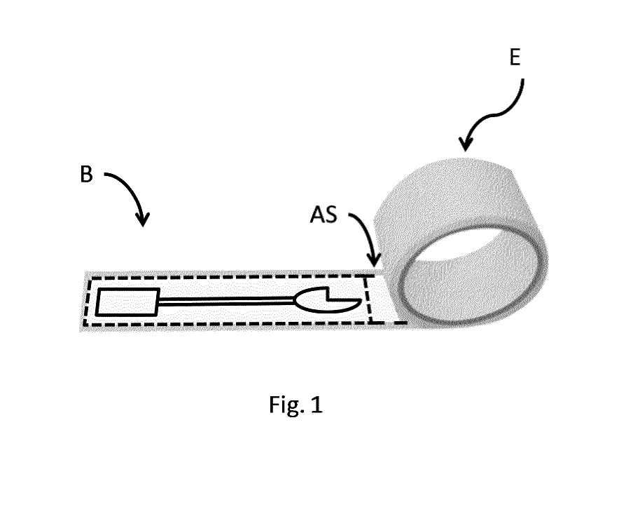

The logical entities of the sensor band B will now be described in further detail. The flexible sensor band B comprises at least one adhesive surface AS for attaching the band to a surface of a rotating or buried element E. Attaching to a surface may thereby also be an attachment within a production process. E.g. in FIG. 1 the flexible sensor band B is attached to a circular portion of the element E. Once attached the flexible sensor band B may be covered by one or more layers of additional material. Such a processing is typical for composite materials such as reinforced (fiber) materials where several layers of fabric are bonded to each other. I.e. in this case, the sensor band B is buried in the material of the element E once production thereof is finished.

The flexible sensor band B comprises at least a sensor arrangement S for detecting mechanical stress at the rotating or buried element E. The term stress may also be understood as mechanical load leading to some deformation measured by the sensor arrangement. Obviously, the sensor arrangement may also comprise a first sensor S₁ and a second sensor S₂ as shown in FIG. 2. Even though the sensors will be described to mechanical stress only, it may also be possible that a sensor band offers a plurality of different sensors, e.g. a mechanical stress sensor S₁ and a temperature sensor S₂ and a humidity sensor S₃ . . . . Sensor thereby encompass not only physically separate entities but also encompass logical entities.

It is noted that e.g. a humidity sensor may be provided by means of a capacitive sensor. A humidity sensor may also be used for detecting curing of ambient material.

The flexible sensor band B further comprises an energy harvesting section BAT. Energy harvesting section is to be understood in a broad sense as a section providing energy. The energy may be stored in some kind of high Capacity capacitors or batteries. Likewise it is alternatively or additionally possible that the energy harvesting section is based on mechanical principles such as piezo elements, inductive elements, solar cells, etc.

The flexible sensor band B further comprises a wireless communication section TX, the wireless communication section TX being adapted to transmit data relating to the detected mechanical stress/deformation respectively temperature and/or humidity of the sensor arrangement S and a unique ID relating to the sensor arrangement S towards a receiving section RX. I.e. the sensor data may easily be associated to a specific sensor. Hence, even in the case of a multitude of data due to a plurality of sensors in reach of a receiving section RX it is easily possible to determine from which sensor band B/which sensor arrangement a specific data set originates. Hence, knowing where a certain sensor band B is arranged allows easy discovery of potentially failing parts. I.e. the system allows or full benefit of big data analysis. I.e. depending on the data format it may be that only a single ID is necessary for a sensor band irrespective of the number of sensor arrangements as long as the data exchange provides for a mean to determine which data originates from which sensor. A simple system employs on ID per Sensor arrangement as shown in FIG. 2 where sensor arrangement S₁ is associated to ID₁ and sensor arrangement S₂ is associated to ID₂.

The receiving section RX in turn may be arranged at a position such that the flexible sensor band B when the rotating or buried element E is passing the receiving section RX may transmit the data towards the receiving section RX.

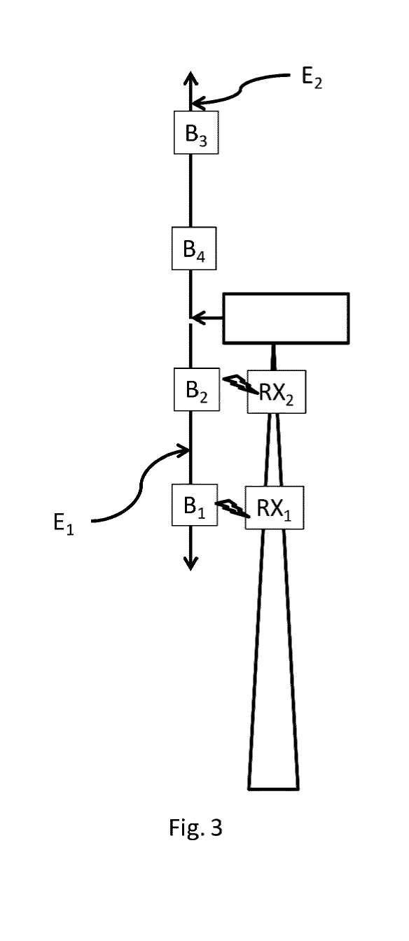

Such a setup may be seen in FIG. 3. There a windturbine is schematically shown having two blades E₁ and E₂. Both blades comprise two sensor bands. I.e. element E₁ comprises a first flexible band B₁ and a second flexible band B₂ while element E₂ comprises a first flexible band B₃ and a second flexible band B₄. The tower of the windturbine comprises two receivers RX₁, RX₂ located such that when the blades are rotating along Receiver RX₁ may receive data transmitted by the respective communication section, e.g. in FIG. 3 the communication section of flexible band B₁ is in reach of the receiving section RX₁ while the communication section of flexible band B₂ is in reach of the receiving section RX₂.

The receiving sections may be also adapted to power the communication section TX in a first interval by transmitting a high power sequence towards the communication section TX while in a second interval the communication section TX is transmitting data towards the receiving section. I.e. in this case the communication section TX may act in the first interval as energy harvesting section BAT.

The system thereby allows for detecting various types of degradation and environmental conditions such that the operation/status of a respective element E may be monitored easily and effectively.

It is to be noted that interpretation of data may be provided on the sensor band itself and/or via externals units in communication with the receiving section RX. I.e. depending on the respective use case it may be necessary to only transmit data in case of certain detected events to reduce the overall data amount and/or to adapt to the operational window allowing for transmission of data, e.g. in case of FIG. 3, the time a blade is passing by within a certain distance allowing for reliable data transmission.

A like sensor band may be produced in various manners.

Exemplarily we will describe a flexible sensor band B which comprises (conductive) (nano-) particles, in particular carbon-nano-particles, within the sensor arrangement S. These particles may be arranged as integrated load and deterioration sensor. E.g. the sensor arrangement S for detecting stress/deformation may be based on a piezo-resistive effect. The particles may be carbon nano-tubes or carbon-black embedded in a polymer. Piezo-resistivity may be understood as a change in resistance due to deformation/stress. I.e. by evaluating the resistivity respectively the change thereof in time it is possible to determine the deformation/stress exerted to the element E. By maintain a log stress/deformation as well as other factors such as temperature/humidity/etc. may be evaluated in its effect over longer period of times and thereby allowing to detect harmful conditions.

In particular, having more than sensor arrangement may also allow for determining damage with better resolution. I.e. in FIG. 3 one could determine by evaluating both sensor arrangements of a blade whether a certain condition is to be found at the outermost region, in between the sensor arrangements or at the innermost region.

In an embodiment the flexible sensor band B comprises an epoxy resin and/or thermoplastic or thermoset polymer. The choice of material may be subject to the respective sensor arrangement as detailed above or may also be subject to further surrounding material.

In an embodiment the communication section TX and receiving section are based on a near field communication device. Thereby it should be appreciated that near field is not fixed to a particular technology such as NFC, (active) RFID but encompasses any kind of communication technology offering a communication within its surrounding, e.g. some meters e.g. 15 m-25 m. The communication system may be sufficiently chosen to match to timing and distance requirements.

As shown in FIG. 2, the sensor band B may optionally comprises a memory MEM for storing data. I.e. as detailed above, the sensor band B may comprise some computing entity CPU allowing for (pre-) evaluation of data before sending. It may also be the case that transmission is to energy consuming such that storing of data is more effective. E.g. in case within a data burst a plurality of sensor data may be transmitted than it is more efficient to wait until the burst may be filled up with stored data rather than wasting a data burst. The memory MEM may be any kind of volatile Memory such as FLASH memory.

As shown in FIG. 2 the sensor band B may optionally comprises a processing entity CPU for processing data of the sensor arrangement S before transmission. I.e. the processing entity may allow for reduction of data amount by pre-evaluation thereby minimizing the overall data traffic. The processing entity CPU may be any kind of general or specialized entity such as microcontroller, a microprocessor, an ASIC or an FPGA.

E.g. the processing entity CPU may evaluate a resistance of a sensor arrangement e.g. by comparing to predefined or programmed threshold value(s). E.g. the threshold value(s) may be altered e.g. due to further knowledge and/or in response to certain events. In case a temperature sensor is also provided, data of a temperature sensor may be used to correct stress data with respect to the temperature.

Temperature may also be used by other systems such as anti-ice systems of wind plants or in case of production of an element E as a process parameter to be monitored.

As detailed above energy harvesting BAT may be understood in a broad sense. In particular the energy harvesting section (BAT) is based on at least one of vibration, rotation or reception of electro-magnetic fields, thermal effects e.g. by using Seebeck-effect, chemical effects such as a battery/accumulator and optical means such as (flexible) solar cells.

A sensor band B may be manufactured in a number of ways. It may be cut of a film; it may at least partially based on a screen printing process. It is common to all embodiments that the elements are integrated into a flexible band which may be attached to any kind of surface of an element to be monitored. The attachment may be performed while the element E to be monitored is manufactured.

It is noted that the manufacturing process of the flexible band B allows employing bare dies for the communication section, energy harvesting section BAT, optional processing entity and/or optional memory MEM. This housing-less dies also known as naked dies allow for thin flexible arrangements allowing for bending onto surface as shown in FIG. 1.

The flexible sensor band B may also be applied during manufacturing of devices to be subject of measurement. I.e. a flexible sensor band B with or without an adhesive surface AS may e.g. applied during a lamination process of a composite material such as carbon-fiber or glass-fiber reinforced material. In particular, the epoxy resin and/or thermoplastic or thermoset polymer used for the flexible sensor band B may offer of same or like chemical compounds as used for lamination. Thereby it is achieved that the flexible sensor band B acting as a supporting layer while being applied actually may merge/dissolve/blur. In particular in that case, the flexible sensor band may no longer be distinguishable as such while from the perspective of the composite material, the sensor band B actually vanished while leaving the sensor functionality. This allows for a smooth integration without adding stress due to different compound systems.

A respective method according to the invention is based on the following steps. In a first step, a manufacturing step, the flexible sensor band B having at least one adhesive surface AS is applied on a rotating or buried element. Once ready, energy harvesting starts thereby providing energy towards the sensor arrangement S and the wireless communication section TX. Upon detecting mechanical stress at the rotating or buried element by sensor arrangement S data relating to the detected mechanical stress of the sensor arrangement S and a unique ID relating to the sensor arrangement S is transmitted towards a receiving section RX.

Hence by means of the invention it is now possible to provide an implantable sensor having high accuracy and reliability and allows for a knowledge-based maintenance of elements difficult to access.

By means of the flexible band and its thin design the system allows for surveillance of any kind of difficult to access elements including adhesive joints. Sensor band according to the invention may be as thin as some micrometer within the sensor arrangement S while even in regions employing dies such as a communication portion TX the overall thickness is less than 0.5 mm.

A database may store data received via the receiving sections RX and allow for easy access to the data allowing for comprehensive data analysis such as automatic alarming and/or active steering such that specific load/Stress conditions are avoided.

When a sensor band B according to the invention is applied to an element E during its production, the sensor band B may also provide data relating to production itself. Hence, the sensor band B enables a history of data right from the start.

The sensor ban B according to the invention may be pre-manufactured such that the resin/polymer is not yet fully cured but will cure once it is applied to the element E to be monitored.

Although the system was described with respect to new devices, it is apparent to a person skilled in the art that the system may also be used as an upgrade to existing systems.

A sensor band B according to the invention may be manufactured by structure layers of a polymeric film having different filling degree. E.g. a layer may be arranged to act as piezo-resistive Sensor arrangement S. Different orientations of layers respectively their contact regions may allow for a directional identification of a stress/deformation. Such layers may be separated by an insulating layer. An antenna as part of the communication section TX may also be provided e.g. by a layer having an increased level of conductive filler material. Such an arrangement may be of particular value when elements are lightning prone such as blades of windturbine. There it is most often a requirement to avoid metallic materials.

Having described the sensor band B as a measuring tool it is also apparent that the sensor band B due to its adhesive surface AS may also be used a structural element in the production of elements E to be monitored.

1. System for inspection of rotating or buried elements, comprising:
a flexible sensor band,
whereby the flexible sensor band comprises a first sensor arrangement for detecting mechanical stress at the rotating or buried element,
whereby the flexible sensor band comprises a second sensor arrangement for detecting humidity at the rotating or buried element,
whereby the flexible sensor band further comprises an energy harvesting section,
whereby the flexible sensor band further comprises a wireless communication section, the wireless communication section being adapted to transmit data relating to the detected mechanical stress of the first sensor arrangement and a unique ID relating to the first sensor arrangement towards a receiving section, whereby the wireless communication section is further adapted to transmit data relating to the detected humidity towards said receiving section,
the receiving section being arrangeable at a position such that the flexible sensor band when the rotating or buried element is passing the receiving section may transmit the data towards the receiving section.

2. System for inspection of rotating or buried elements according to claim 1, whereby the flexible sensor band comprises nano-particles, in particular carbon-nano-particles, within the first sensor arrangement.

3. System for inspection of rotating or buried elements according to claim 1, whereby the flexible sensor band comprises an epoxy resin and/or thermoplastic or thermoset polymer.

4. System for inspection of rotating or buried elements according to claim 1, whereby the wireless communication section is a near field communication system.

5. System for inspection of rotating or buried elements according to claim 1, whereby the sensor band further composes a memory tor storing data.

6. System for inspection of rotating or buried elements according to claim 1, whereby the sensor band further comprises a processing entity for processing data of the sensor arrangement before transmission.

7. System for inspection of rotating or buried elements according to claim 1, whereby the energy harvesting section is based on at least one of vibration, rotation or reception of electro-magnetic fields.

8. System for inspection of rotating or buried elements according to claim 1, whereby the sensor band at least in part manufactured by a screen printing process.

9. System for inspection of rotating or buried elements according to claim 1, whereby the flexible sensor band comprises a third sensor arrangement for detecting temperature at the rotating or buried element, whereby the wireless communication section is further adapted to transmit data relating to the detected temperature and/or humidity towards said receiving section.

10. System for inspection of rotating or buried elements according to claim 1, whereby the flexible sensor band having at least one adhesive surface for attaching on a rotating or buried element.

11. System for inspection of rotating or buried elements according to claim 1, whereby the flexible sensor band is dissolved within a rotating or buried element leaving the first sensor arrangement and the second sensor arrangement as well as the wireless communication section embedded within the rotating or buried element.

12. Method for inspection of rotating or buried elements by a system according to claim 1, comprising the steps of:
applying the flexible sensor band during production of a rotating or buried element,
dissolving the flexible sensor band within the rotating or buried element,
energy harvesting for providing energy towards the sensor arrangement and the wireless communication section,
detecting mechanical stress at the rotating or buried element by sensor arrangement,
transmitting data relating to the detected mechanical stress of the sensor arrangement and a unique ID relating to the sensor arrangement towards a receiving section.

13. System for inspection of rotating or buried elements, comprising:
a flexible sensor band,
whereby the flexible sensor band comprises a first sensor arrangement for detecting mechanical stress at the rotating or buried element,
whereby the flexible sensor band comprises a second sensor arrangement for detecting humidity at the rotating or buried element,
whereby the flexible sensor band further comprises an energy harvesting section,
whereby the flexible sensor band further comprises a wireless communication section, the wireless communication section being adapted to transmit data relating to the detected mechanical stress of the first sensor arrangement and a unique ID relating to the first sensor arrangement towards a receiving section, whereby the wireless communication section is further adapted to transmit data relating to the detected humidity towards said receiving section, wherein the receiving section being arrangeable at a position such that the flexible sensor band when the rotating or buried element is passing the receiving section may transmit the data towards the receiving section,
whereby the flexible sensor band comprises nano-particles, in particular carbon-nano-particles, within the first sensor arrangement,
whereby the flexible sensor band comprises an epoxy resin and/or thermoplastic or thermoset polymer,
whereby the wireless communication section is a near field communication system,
whereby the sensor band further comprises a memory for storing data,
whereby the sensor band further comprises a processing entity for processing data of the sensor arrangement before transmission,
whereby the energy harvesting section is based on at least one of vibration, rotation or reception of electro-magnetic fields,
whereby the sensor band is at least in part manufactured by a screen printing process,
whereby the flexible sensor band comprises a third sensor arrangement for detecting temperature at the rotating or buried element, whereby the wireless communication section is further adapted to transmit data relating to the detected temperature and/or humidity towards said receiving section,
whereby the flexible sensor band having at least one adhesive surface for attaching on a rotating or buried element, and
whereby the flexible sensor band is dissolved within a rotating or buried element leaving the first sensor arrangement and the second sensor arrangement as well as the wireless communication section embedded within the rotating or buried element.
